(19) United States
(12) Patent Application Publication
(10) Pub. No.: US 2006/0123635 A1
(43) Pub. Date: Jun. 15, 2006

(54) Combination blower, trimmer and edger for tending vegetation

(75) Inventors: Edward P. Hurley, Overland Park, KS (US); Drake L. Koch, Kansas City, MO (US)

Correspondence Address: Kenneth W. Iles;Law Offices of Kenneth W. Iles, 9903 West 129th Street, Overland Park, KS, 66213-3222, US

(73) Assignee: HEOW, Inc., Overland Park, KS (US)

(21) Appl. No.: 11/008,037

(22) Filed: Dec. 9, 2004

(51) Int. Cl. B26B 7/00

(52) U.S. Cl. 30/276

(57) ABSTRACT

A lawn care apparatus includes an impeller seated in a plenum connected to duct work for blowing, and a string trimmer head, both connected to a gasoline engine or an electric motor, either corded or battery operated, through a drive shaft for simultaneous rotation in the same direction. An adjustable handle allows the operator to move the handle into a variety of different positions that allow the operator to use the apparatus with the rotating string of the string trimmer rotating either a horizontal or vertical plane without changing his posture or position. The adjustable handle also allows adjustment of the handle so that the apparatus to be used by either right-handed or left-handed operator using the same posture.

### CROSS-REFERENCE TO RELATED APPLICATIONS

Not Applicable.

### STATEMENT REGARDING FEDERALLY SPONSORED RESEARCH OR DEVELOPMENT

Not applicable.

### STATEMENT REGARDING A SEQUENCE LISTING

Not applicable.

### BACKGROUND OF THE INVENTION

The present invention is related to an apparatus for facilitating lawn trimming care. More particularly, the present invention combines a blower inside a housing having an exit blower duct and a string trimmer head, both driven simultaneously by a motor connected to a drive shaft.

### DESCRIPTION OF THE RELATED ART INCLUDING INFORMATION DISCLOSED UNDER 37 C.F.R. 1.97 and 1.98

Complete lawn care now typically includes trimming areas that lawn mowers cannot access easily; edging vegetation along defined perimeters, such as curbs; and removing the vegetation debris, such as lawn trimmings or fallen leaves, from areas where they are not wanted, such as sidewalks and driveways, typically by blowing them away to an area where they will not be seen, such as the lawn. Carrying out these separate tasks has traditionally required different and separate tools, namely, a lawn mower, a string trimmer, an edger and a blower.

In commercial applications particularly, such as grooming golf courses, the necessity for using different and separate tools for these tasks leads to lost time and inefficiency because workers must return to a tool shed or truck, often located at some distance from the workers, to retrieve the appropriate tool. A worker may carry and use a particular tool, for example, a string trimmer, for several hours without pause, leading him far from his tool shed or truck. The worker cannot carry all these different tools with him due to their bulk and weight.

Further, many workers remove the debris shield from string trimmers to provide a better view of the work area, but the debris shield is designed to help prevent flying debris from striking the worker in the eyes or other sensitive areas.

Combining the functionality of some of these separate tools into a single tool would save time and money, including capital outlay for the tools.

Some efforts in that direction have been taken. For example, U.S. Pat. No. 4,773,471 discloses separate operating heads, such as a string trimmer head or a blower head, that can be attached and detached from the same power plant and drive train, saving the expense of a second motor. This system still requires that a significant subassembly of the tool be removed and replaced by another tool, requiring the worker to carry separate tools and to change operating heads on the tool. This system has the same disadvantages as having separate tools when they are used.

U.S. Pat. No. 4,187,577 discloses a blower chute that can be strapped onto the bottom of a string trimmer with a bungee cord, but does not allow the string trimmer function to be used when the blower attachment is installed, requiring the operator to carry separate subsystems and install and remove them to carry out the separate functions of trimming and blowing.

U.S. Patent Application Publication Number US 2002/0007559 discloses a string trimmer with a specially designed shroud that is supposed to help the rotating string of the string trimmer to function as a blower. While it has long been known that the rotating string of the string trimmer provides some blowing forces, they tend to be non-directional and even this reference discloses that any blowing action is basically downward and outward from the rotating string, which provides little benefit in debris removal from sidewalks and so forth. Further, any blowing force generated by the rotating string is minimal and will not move debris any significant distance.

U.S. Pat. No. 6,442,845 discloses a string trimmer that can be converted to a blade trimmer and that can be modified to attach a blower flute or scroll to direct air flow generated by a cooling fin that is part of the string trimmer spool and designed to cool the motor of the apparatus. The use of this fan in a attempt to create a blower function is inadequate because it utilizes a fan that is designed only for motor cooling and is structurally a part of a string trimmer head, limiting its utility for actually blowing debris, due to its position and its use to cool the motor. A string trimmer head that does not include a cooling fan could apparently not be used with this device.

Further, many lawn equipment operators use a string trimmer for basic edging by rotating the handle of the string trimmer so that the string rotates in a generally vertical plane and the end of the string strikes the ground adjacent to a sidewalk or the like. To use a string trimmer in this manner is typically a very awkward operation that places the motor close to the operator's head and requires a back bending contortions that are uncomfortable and may be unsafe. A string trimmer or the like that could easily be adjusted to allow comfortable use with the rotating string in a vertical plane would be a welcome improvement, but none appears to be available, as would a lawn care apparatus that can be easily adjusted for convenient use by either a right-handed or a left-handed operator.

Therefore, there is a need for a single lawn care apparatus that can be used as string trimmer, blower and edger; that will perform these functions as well as traditional separate tools; that provides superior trimming as a result of the simultaneous blower function; that can use either an internal combustion engine or an electric motor as a power source; that can use a variety of conventional string trimmer heads; that can be easily adjusted to allow the operator to operate the trimming string in a vertical plane without changing the operator's posture or position; and that can easily be adjusted for left-handed or right-handed operators.

### BRIEF SUMMARY OF THE INVENTION

Accordingly, it is a primary object of the present invention to provide a single lawn care apparatus that can be used as string trimmer, blower and edger.

It is another object of the present invention to provide a single lawn care apparatus that will perform these functions as well as traditional separate tools.

It is another object of the present invention to provide a single lawn care apparatus that provides superior trimming as a result of the simultaneous blower function.

It is another object of the present invention to provide a single lawn care apparatus that can use either an internal combustion engine or an electric motor as a power source.

It is another object of the present invention to provide a single lawn care apparatus that can use a variety of conventional string trimmer heads.

It is another object of the present invention to provide a single lawn care apparatus that can be easily adjusted to allow the operator to operate the trimming string in a vertical plane without changing the operator's posture or position.

It is another object of the present invention to provide a single lawn care apparatus that can easily be adjusted for left-handed or right-handed operators.

To achieve these objects, the present invention includes an impeller seated in a plenum connected to duct work for blowing, and a string trimmer head, both connected to a gasoline engine or an electric motor, either corded or battery operated, through a drive shaft for simultaneous rotation in the same direction. The blower outlet includes an oval or round shaped outlet nozzle for concentrating and directing the flow of air from the blower. The rotating string trimmer creates some draft and the air flow from the blower creates low air pressure above the rotating string, maintaining the string along a straighter line and a higher line that would be the case without the blower's operating and lifting the vegetation to be trimmed, allowing for more even height of the resulting trimmed vegetation.

An adjustable handle allows the operator to move the handle into a variety of different positions that allow the operator to use the apparatus with the rotating string of the string trimmer rotating either a horizontal or vertical plane without changing his posture or position. The adjustable handle also allows adjustment of the handle so that the apparatus to be used by either right-handed or left-handed operator using the same posture.

Other objects and advantages of the present invention will become apparent from the following description taken in connection with the accompanying drawings, wherein is set forth by way of illustration and example, the preferred embodiment of the present invention and the best mode currently known to the inventor for carrying out his invention.

### BRIEF DESCRIPTION OF THE SEVERAL VIEWS OF THE DRAWINGS

FIG. 1 is an isometric view of a combination blower, trimmer and edger for tending vegetation (lawn care apparatus) according to the present invention shown in use for trimming and blowing.

FIG. 2 is an isometric view of the lawn care apparatus of FIG. 1 illustrating the apparatus in use and highlighting the blower function.

FIG. 3 is an isometric view of the lawn care apparatus of FIG. 1 illustrating the apparatus in use and highlighting the edging function.

FIG. 4 is an isometric view of the lawn care apparatus of FIG. 1.

FIG. 5 is an exploded isometric view of the working head of the lawn care apparatus of FIG. 1.

FIG. 6 is an exploded isometric view of the working head of the lawn care apparatus of FIG. 1 showing the device utilizing a different style of string trimmer.

FIG. 7 is an isometric view of the upper portion of a clam-shell housing and shroud of the lawn care apparatus of FIG. 1 shown from below.

FIG. 8 is an exploded isometric view of a typical motorized drive train for rotating the blower and string trimmer of the lawn care apparatus of FIG. 1 taken along the lines 8-8 of FIG. 4.

FIG. 9 is an exploded isometric view of a J-handle according to the lawn care apparatus of FIG. 1.

FIG. 10 is an isometric view of the J-handle of FIG. 9 showing the J-handle set into the storage position.

FIG. 11 is an isometric view of the J-handle of FIG. 9 showing the J-handle in the trimming position.

FIG. 12 is an isometric view of the J-handle of FIG. 9 showing the J-handle set into the edger position.

FIG. 13 is an isometric view of the J-handle of FIG. 9 showing the J-handle set into the blower position.

### DETAILED DESCRIPTION OF THE INVENTION

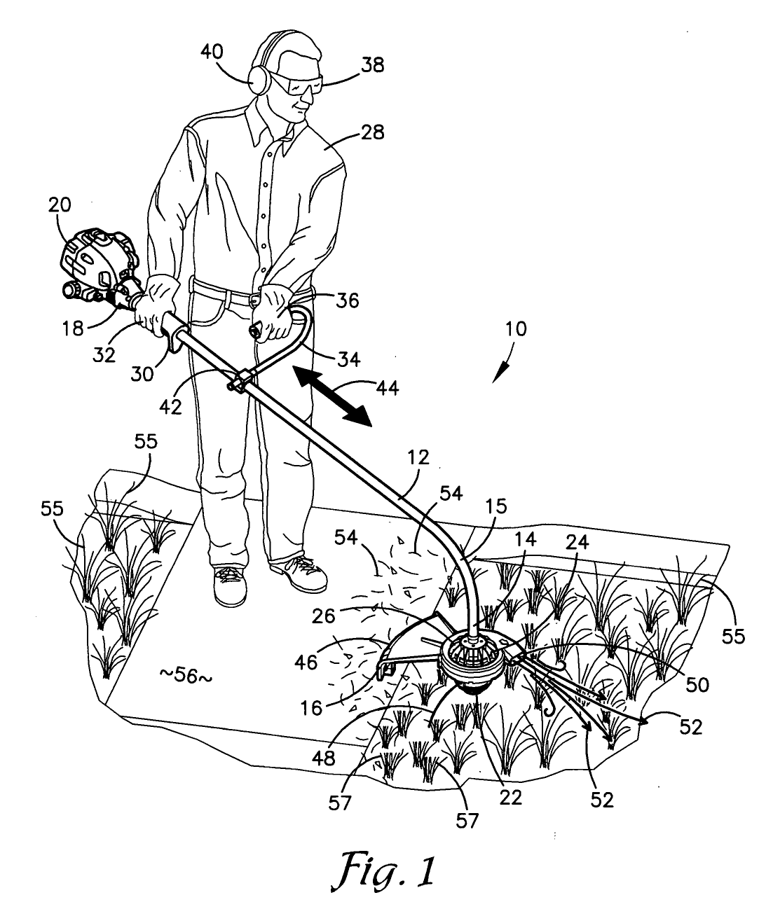

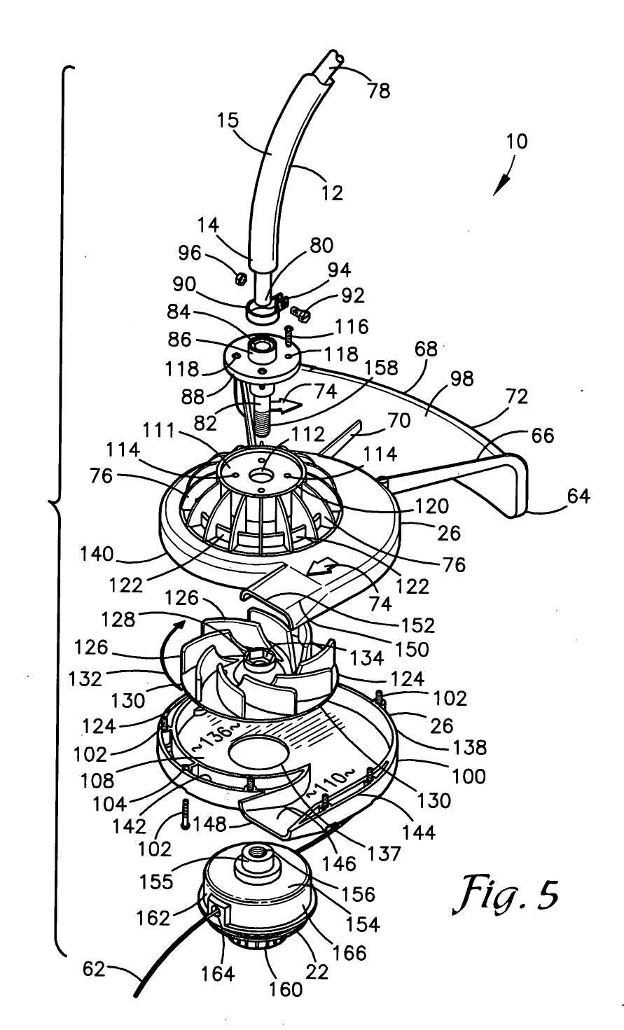

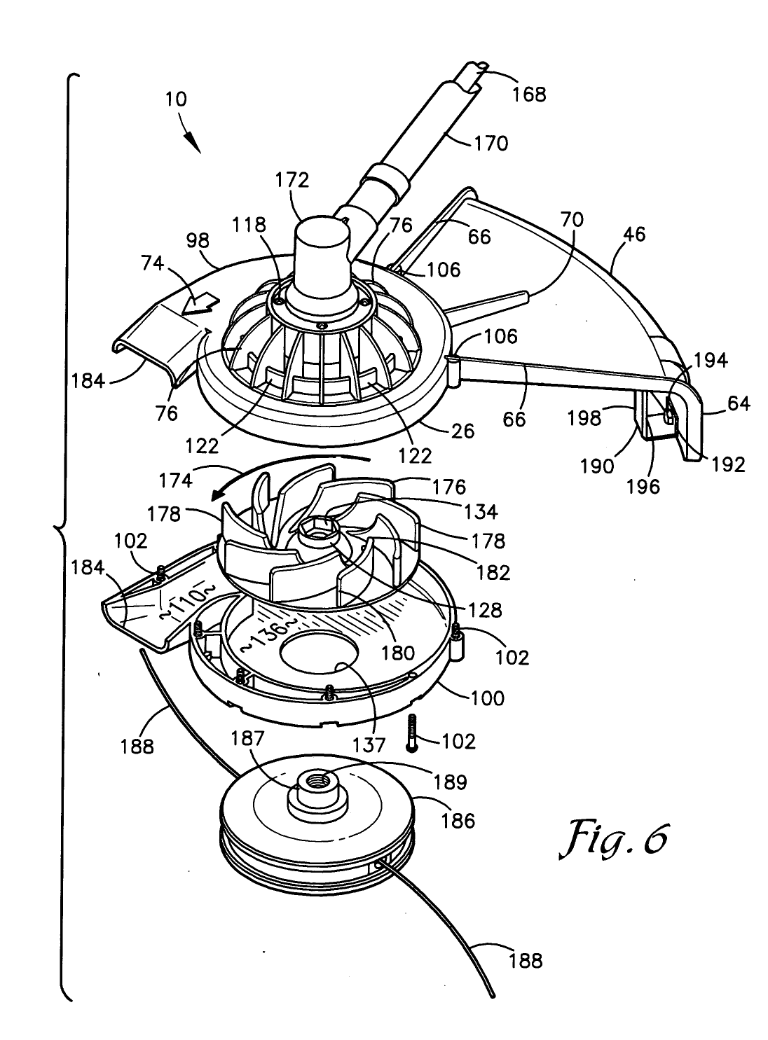

Referring to FIG. 1, a combination blower, trimmer and edger for tending vegetation, that is, a lawn care apparatus, 10 according to the present invention includes an elongated tubular drive shaft housing 12 having a lower end 14 with a working head 16 attached to it and an upper end 18 having a motor 20 connected to it. The motor 20 rotates a drive shaft housed within the drive shaft housing 12 that includes a bend 15 proximate to the working head 16, but which may be a straight drive shaft housing as shown in FIG. 6. The bent drive shaft housing 12 allows the working head 16 to be oriented at basically 90° to the portion of the drive shaft housing that it is connected to, whereas the straight shaft version includes a working head attached to the straight tubular drive shaft housing at an angle of about 30°. Either style of drive shaft housing may be used with the lawn care apparatus 10. The rotating motor in turn rotates drive shaft that rotates a string trimmer head 22 and a blower impeller 24, which is visible through the openings in the upper portion of the blower housing 26. A human operator 28, who is right-handed as shown, grasps a shaft handle, or grip, 30, which is adjacent to the lower end of the motor 20 and consists of a cushion for about an upper portion of the drive shaft housing 12, in his right hand 32 in any J-handle 34 in his left hand 36. The operator 28 wears safety goggles 38 to protect his eyes from flying debris and ear protectors 42 prevent hearing loss that may result from the noise of the motor 20, which may be either a gasoline engine of four stroke or two-stroke design, an electric motor, which may be battery powered or powered by conventional AC power through a cord.

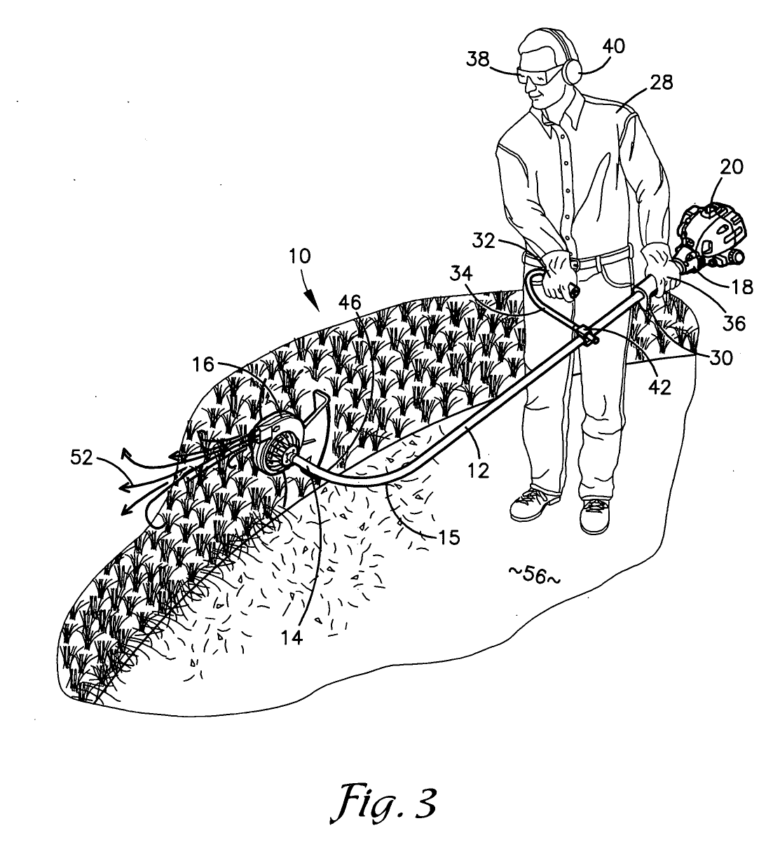

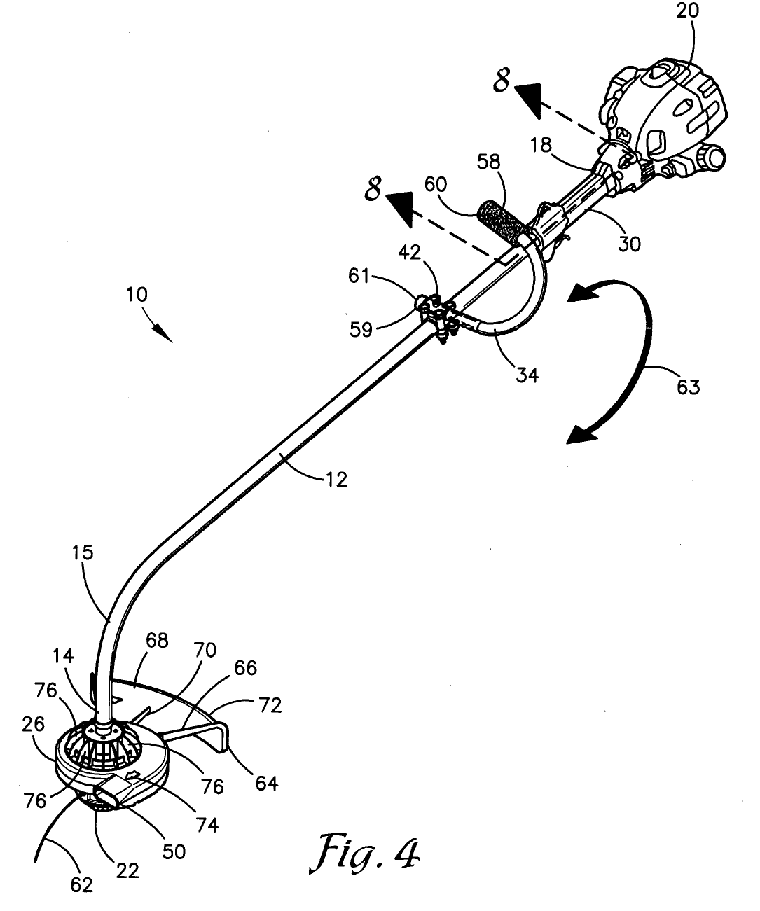

Still referring to FIG. 1, the J-handle 34 is connected to the drive shaft housing 12 by an adjustable coupling block 42, which allows the operator to slide the J-handle up or down the drive shaft housing 12 as shown by the double headed arrow 44 to a convenient position for a particular operator 28. The shaft handle grip 30 is located at the approximate balance point for the lawn care apparatus 10 and the J-handle 34 is preferably adjusted so that it is located approximately at shoulder width of the operator down the drive shaft housing from the shaft handle grip 30. The J-handle 34 can be adjusted into a number of different positions to facilitate the use of the lawn care apparatus 10 in different modes, as shown in FIG. 3 and as discussed in greater detail in connection with FIG. 4 and FIGS. 9-13.

Still referring to FIG. 1, the working head 16 is shown basically horizontally oriented, that is for example, the guard shroud 46 is horizontal, as are the rotating trimmer strings 48, which is the most conventional position for ordinary trimming and which causes a basically horizontal blowing force to be emitted from the oval-shaped nozzle 50, which may alternatively be a round shaped cross section nozzle, creating a basically roughly horizontal airflow as indicated by the airflow lines arrow lines 52. The string trimmer head 22 portion of the working head 16 creates vegetation clippings 54 from the standing overgrown vegetation 55 in the conventional manner, which are most clearly visible on the sidewalk 56. While the trimming function is being executed, resulting in the trimmed vegetation 57, the blower and power 24 is rotating within the blower housing 26, ejecting airflow along the air flow arrow lines 52, blowing much of the debris in that direction and reducing the amount of debris ejected radially from the string trimmer head 22, resulting in fewer vegetation clippings 54 on the sidewalk 56 or other surface where vegetation clippings 54 are undesirable.

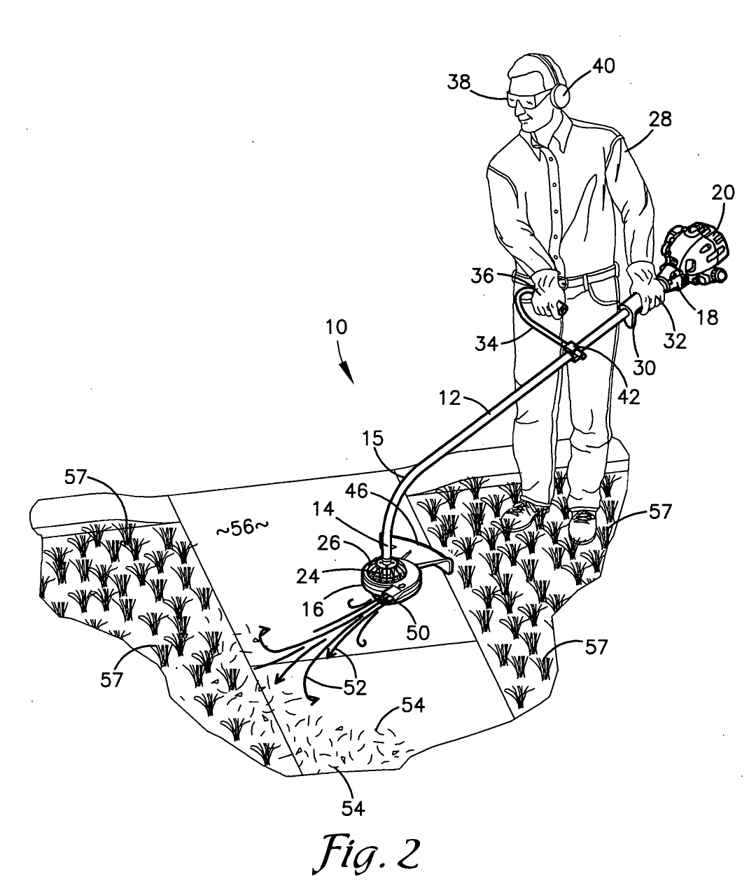

Referring to FIG. 2, as shown, when the trimming function has been completed, the operator 28 orients the lawn care apparatus 10 such the rotating strings of the string trimmer 20 to do not engage any vegetation and utilizes the blower function to disperse and remove vegetation clippings 54 and other unwanted debris from the sidewalk 56.

Referring to FIG. 3, the J-handle is rotated 180° (either clockwise or counterclockwise), allowing the operator 28 to maintain the same posture and stance while the working ahead 16 is vertically oriented and operates vertically so that the string trimmer head 22 can function effectively as an edger that cuts vegetation along a sharp vertical line. This type of edging does not cut a channel into the ground as an edger with an metal actual blade does, but use of a string trimmer for casual edging is very common and is less disruptive to the root system of the vegetation. Further, the adjustable J.-handle allows the lawn care apparatus tend to be used by either right-handed or left-handed operators utilizing the same posture and gripping techniques, as illustrated in FIG. 3 where the operator's 28 left hand 36 grips the J-handle and his right hand 32 grips the shaft handle grip 30.

Referring to FIG. 4, J-handle 34 includes a comfort nonslip grip 58 on its distal end 60 and an end cap 59 on the proximal end 61. The J-handle can be rotated along either direction of the double headed arrow 63, with positive stops at preset positions described below. The string trimmer head 22 includes 124 trimming strings 62 that project outwardly from the generally circular string trimmer head 22, with the exact number of trimming strings 62 depending on the style of string trimmer head 22 that is employed. The lawn care apparatus 10 can accommodate many different styles of string trimmer heads 22. The trimming strings 62 are conventional and are typically made of medium gauge nylon.

Still referring to FIG. 4, the guard shroud 46 is a pie-shaped shroud defining a segment of a circle approximately 45° 290° of arc with the preferable degree of arc being about 60° and projects toward from the blower housing 26 toward the motor 20 to protect the operator 28 from flying debris. The guard shroud 46 is integrally formed with the plenum on an outer and outside surface of the plenum 108 on the upper blower housing section 108, preventing it from being removed from the lawn care apparatus 10. Along an outer perimeter of the shroud 46 is a skirt 64 that further reduces the amount of debris scattered toward the operator 28. An upstanding reinforcing rib portion 66 lies along each side edge of the upper surface 68 of the shroud 46 and an abbreviated upstanding rib 70 lies in the center of the two edges of the upper surface 68 of the shroud 46 and projects outwardly from the blower housing 26 about half way to the outer perimeter 72 of the shroud 46 to improve the strength of the shroud 46. A directional arrow 74 is formed by molding, embossing, painting, or the like into an upper portion of the blower housing 26 to indicate to the operator redirection of airflow created by the blower. The blower housing 26 includes a plurality of upstanding structural connecting spaced apart vanes 76 arrayed in a circular pattern and each having an upper end connected to the flat circular top 111, with the air moved by the impeller 24 drawn into the blower housing 26 through the spaces between the vanes 76. The air inlets are located above the shroud 46 in order to reduce the possibility that lawn debris might be drawn into the air inlets. A screen or other filter can be placed over the air inlets, preferably under the housing vanes 76.

Still referring to FIG. 4, the impeller 24 is preferably a centrifugal fan, such as the impeller 24 illustrated. A propeller fan may be used, but is inferior because a propeller fan tends to force clippings downward rather that outwardly from the lawn care apparatus 10, thereby providing less control over the direction of disbursal of the clippings and diminishing the quality of the resulting lawn care. The three basic types of centrifugal fans are the forward curve type, the radial or straight blade type, and the backward inclined type. Each of these basic types have certain advantages and disadvantages, but any type may be advantageously used in the lawn care apparatus 10.

The impeller 24 of the lawn care apparatus 10 is a separate part that is attached to and can be removed from the drive shaft 78, can be omitted if desired, can be easily replaced and is not a blower element use to cool the motor or the drive shaft.

Referring to FIG. 5, the drive shaft 78, which is preferably a rigid drive shaft, but may also be a flexible drive shaft, includes a distal end 80 that fits into a coupling in the terminal threaded drive shaft 82 in a conventional fashion after passing through the bushing 84, which is press fitted into an upstanding annular flange portion 86 on a flange plate 88. When the drive shaft 78 is seated into the threaded terminal drive shaft 82, the collar clamp 90 is tightened about the drive shaft housing 12, which is seated over the upstanding annular flange portion 86 by inserting the bolt 92 through the apertures in the clamp tabs 94 and securing it with the nut 96.

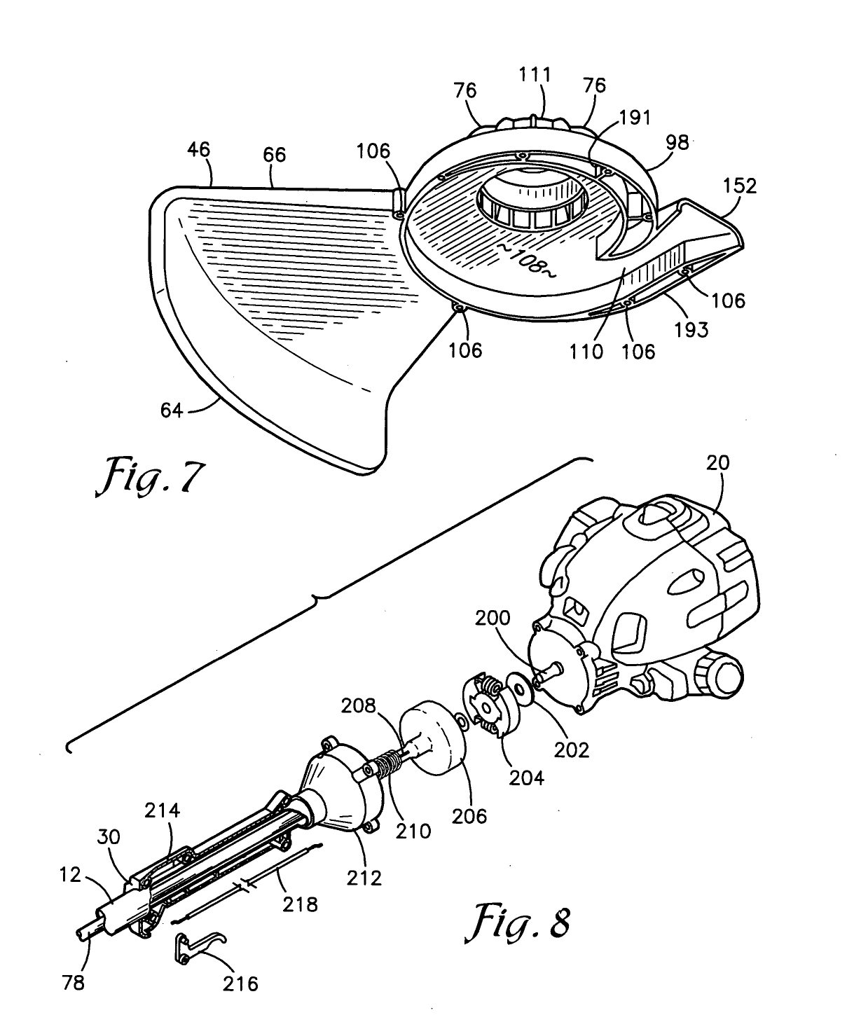

Still referring to FIG. 5, the blower housing 26 includes an upper blower housing section 98 and a lower blower housing section 100, which are fastened and held together by the screws 102 that project upwardly through the perimeter of the lower blower housing section 100 through the apertures 104 and which are received in corresponding apertures 106 along the bottom edge of the upper blower housing section 98 (visible in FIG. 7), forming a plenum 108. The blower housing 26 includes the impeller plenum portion 108, and a conch shell-type blower duct section 110 that spins outwardly and directs the flow of air from the impeller 24. The upper blower housing section 98 further includes the plurality of upstanding vanes 76, that are equally spaced and that are curved inwardly as they rise to a flat circular top 111 that is penetrated by the central aperture 112, which receives the terminal threaded drive shaft 82 and a four smaller equally spaced apertures 114 for receiving four screws 116 after they pass through apertures 118 in the annular flange plate 86, fastening the two pieces together. The flange plate 86 fits into a circumferential rim 120 about the perimeter of the circular top 111, providing a positive fit. Upstanding reinforcing flanges 122 are located between the vanes 76 at the lower ends of the vanes 76.

Still referring to FIG. 5, the impeller 24, which can be attached to or detached from the string trimmer head 22, includes a circular planar base portion 124 with a number of upstanding impeller blades 126 attached to its upper surface, with each impeller blade 126 curving in counterclockwise fashion from the hub 128 outwardly to the perimeter 130 of the base portion 124. In use, the impeller 24 is rotated in the direction shown by the arrow 132, that is clockwise, that is, so that the back of the curves of the impeller blades 126 rotate toward the duct portion 110. In the center of the hub 128 is a central hexagonal aperture 134 that receives a corresponding hexagonal length of the terminal end drive shaft 82 with a tight fit, insuring that the impeller 24 rotates in tandem with the drive shaft 78. A frangible key inserted into a key way or a clutch may be utilized where the terminal end drive shaft 82 engages the impeller 24 so that the impeller becomes disengaged from the drive shaft under certain designed stress. The impeller 24 seats firmly on the terminal end drive shaft 82 and floats inside the impeller plenum portion 108 of the blower housing 26 with the bottom surface of the impeller base 124 just above the flat upper surface 136 of the lower blower housing section 100. The flat upper surface 136 includes an access aperture 137 that admits the upstanding hub 155 of the string trimmer head 22 so that the threaded bore 156 can be threaded onto the drive shaft 82 at the threaded end 158. Any type of design of impeller or blower can be used.

Still referring to FIG. 5, the lower blower housing section 100 includes an upstanding perimeter wall 138 that aligns with the corresponding depending lip perimeter wall 140 of the upper blower housing section 98, with a first double wall section 142 and a second double wall section 144 along the lower housing section 100 to strengthen the upstanding perimeter wall 138. An upward scoop sloped wall 146 formed adjacent to the exit end 148 of the lower blower housing section 100 and a corresponding downward scoop sloped wall 150 adjacent to the exit end 152 of the upper blower housing section 98 come together to form the oval-shaped blower outlet nozzle 50, which may alternatively have a circular cross section, and which accelerates the flow of air from the scroll duct section 110 and, in accordance with the Bernoulli principle, provides lift to anything below the level of the air flow from the blower nozzle 50, such as the vegetation clippings 54 and even the standing overgrown vegetation 55. Further, the same directional rotation of the trimming strings 62, 188 creates lift and radial outward air flow, further aiding in the disbursal of the vegetation clippings 54 and other debris.

Still referring to FIG. 5, the string trimmer head 22 includes a top portion 154, that includes a threaded bore 156, which receives the threaded lower end 158 of the terminal threaded drive shaft 82 to drive the string trimmer head 22 when the motor 20 is running. Any type of string trimmer head 22 may be used and measures may be taken to insure that the string trimmer head 22 becomes disengaged from the drive shaft 78 in case of excess stress on the string trimmer head 22 in order to prevent injury to a operator 28. As shown in FIG. 5, the string trimmer head 22 includes a bump-and-feed mechanism 160, with the trimming string 48 coiled up inside the head housing 162 and projecting through the aperture 164 in the side wall 166 of the head housing 162.

Referring to FIG. 6, to an a typical commercial lawn care apparatus 10 includes a straight drive shaft 168 enclosed in a tubular straight drive shaft housing 170 which is connected to a transmission housing 172 at an angle of about 60° so that the operator 28 can hold the lawn care apparatus 10 at a convenient angle while maintaining the general plane of rotation of the separate trimmer strings 188 in a generally horizontal plane. The transmission is a conventional two-gear direct drive transmission that typically reduces the speed of rotation by half and doubles the torque delivered to the trimmer strings 188. The transmission reverses the direction of rotation of the final drive shaft, providing rotation in the direction indicated by the directional arrow 174, requiring an impeller 176 having spaced upstanding vanes 178 that spiral inwardly from a left-hand outer edge 180 to an inner right-hand edge 182, the opposite of the spiral pattern of the impeller 22. In this case, it is desirable that the outlet nozzle 184 be positioned on the right-hand side of the lawn care apparatus 10 as viewed from the vantage point of an operator 28 using the lawn care apparatus 10, which is on the opposite side of the lawn care apparatus 10 from the apparatus illustrated in, for example, FIG. 5. The string trimmer head 186 shown in FIG. 6 clamps the separate trimmer strings 188, which are precut into relatively short lengths, into the string trimmer head 186 by centrifugal force operating on cams that grip an end of the separate trimmer strings 188, as disclosed in, for example, U.S. Pat. No. 5,887,348. The string trimmer head 186 includes a central upstanding hub 187 having a threaded bore 189 that receives a threaded end of a drive shaft from the transmission, essentially as described above regarding, for example, FIG. 5. Any of the four basic types of string trimmer heads, that is, automatic feed heads, semi-automatic head, manual feed head or fixed-line length head, can be used on the lawn care apparatus 10 and each has different advantages and disadvantages. Non-string trimmer heads may also be used and these include, for example, a pivoting blade trimmer head such as is disclosed in United States Patent Application Publication Number US 2001/00276610.

Still referring to FIG. 6, a trimming string cutter blade 190 is a U-shaped bracket having a side wall 192 fastened to the skirt 64 of the shroud 46 by a screw 194 and having an upstanding side wall 196 with a sharpened cutting edge 198, that automatically cuts the trimming strings 62, 188 to the proper length when the trimming strings 62, 188 are rotated rapidly by the motor 20. A trimming string cutter blade 190 is installed on all embodiments of the lawn care apparatus 10. In other respects, the embodiment of FIG. 6 is the same as that described above.

Referring to FIG. 7, the upper blower housing section 98 includes a first double wall portion 191 and a second double wall section 193, which align with the first double wall portion 142 and the second double wall portion 144 of the lower blower housing section 100, respectively when the upper and lower blower housing sections are assembled. Referring to FIG. 8, a typical motive drive train for rotating the impeller 24, 176 and the string trimmer head 22, 186 includes a gasoline motor 20, which has an output drive shaft 200 that receives a clutch washer 202 and is connected to a clutch rotor assembly 204 that fits into a clutch drum assembly 206. The output shaft 208 of the clutch drum assembly 206, with the external spring 210 on it, fits into the clutch cover assembly 212, from which the drive shaft 78 emerges after passing through the drive shaft housing 12, ultimately rotating the impeller 24, 176 and the string trimmer head 22, 186, as described above. Adjacent to the clutch cover assembly 212 and disposed over the drive shaft housing 12 is shaft handle grip 30, which is formed by the outer surface of the throttle housing and trigger assembly 214, which includes the attached throttle trigger 216 and throttle cable 218. Other suitable types of drive trains may be employed, as well as other types of motors, for example, electric motors.

Referring to FIG. 9, the J-handle includes a symmetrical bend area 220 that moves the comfort non-slip grip 58 away from the drive shaft housing 12, making the grip 58 easier to use. The adjustable coupling block 42 that connects the proximal end 61 of the J-handle to the drive shaft housing 12 includes a bottom clamping body 222 with a channel 224, of uniform semi-circular cross section, through it, which is the concave mirror image of the convex curve shape of the drive shaft housing 12 so that the channel 224 fits over a lower portion of the drive shaft housing 12. About a roughly rectilinear perimeter in the corners of the bottom clamping body 222 are four bosses 226 with an aperture 228 in each boss. An upper clamping body 230 likewise includes a longitudinal channel 232 of uniform semi-circular cross section for fitting over a portion of the top of the drive shaft housing 12 and four upper bosses 234 on the corners of the basically rectilinear top view shape of the upper clamping body 230, each having an aperture 236. On an upper surface 238 of the upper clamping body 230 is formed a bottom handle receiving channel 240. On top of the upper clamping body 230 is attached a J-handle cover plate 242, which includes a boss 244 in each corner and an aperture 246 through each boss 242 and a longitudinal concave handle receiving channel 248 that is aligned with the bottom handle receiving channel 248. A positioning groove 250 is formed about a portion of the circumference of the J-handle 34 adjacent to the proximal end 61 and receives a registration screw 252, which is inserted upwardly through the aperture 254 and is secured by the castle nut 256.

Still referring to FIG. 9, the proximal end 61 of the J-handle 34 is inserted between the upper surface 238 of the upper clamping body 230 and the J-handle cover plate 242 with the J-handle 34 lying between the bottom handle receiving channel 240 and the handle receiving channel 248 with the registration screw 252 aligned with the positioning groove 250, and the bottom clamping body 222 pressed against the drive shaft housing 12, with these parts being secured together by the four socket cap head machine screws 260 secured by the spacers 262 and castle nuts 264. Force on the J-handle cover plate 242 is adjusted to provide sufficient frictional engagement to retain the J-handle in the desired set position, while at the same time allowing axial rotation of the J-handle within the range of motion permitted by the stop means positioning groove 250 by adjusting tension on the screws holding the J-handle cover plate 242 in place. A recessed spring-loaded ball or the like may be substituted for the registration screw 252.

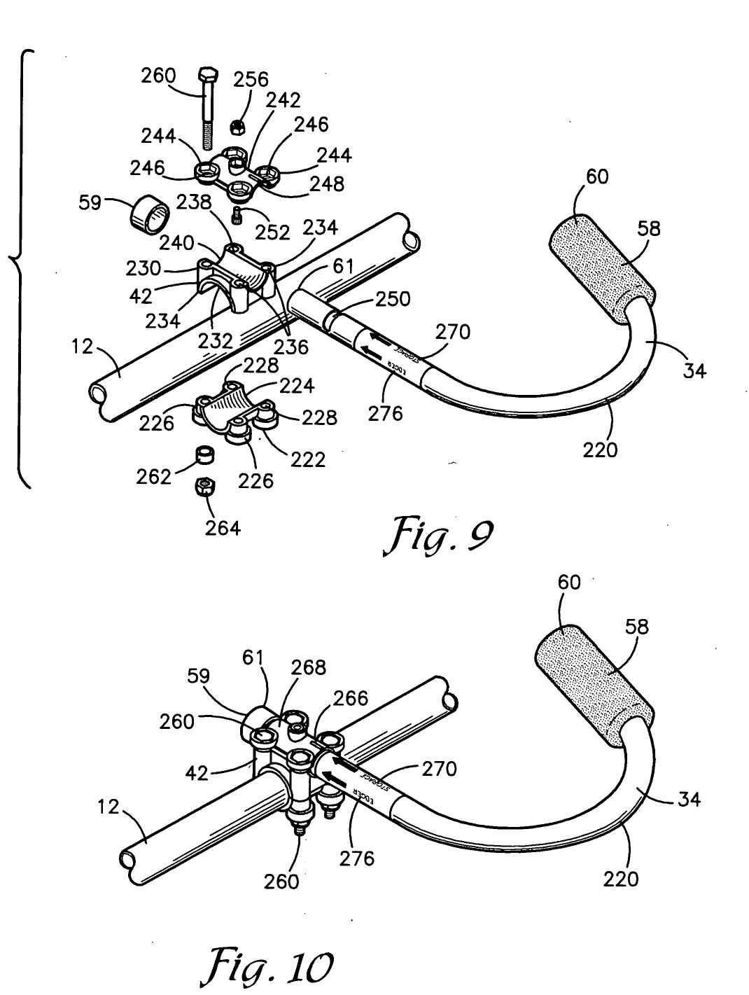

Referring to FIG. 10, an indexing mark 266 is placed on the top face 268 of the J-handle cover plate 242 and indexing signs and arrows are marked on the J-handle 34 adjacent to the proximal end 61 so show the operator 28 the exact position of the J-handle 34 for performing certain operations with the J-handle 34 in an ergonomically advantageous position. For example, the label and arrow for storage, that is the storage indexer 270 indicates that when the storage indexer 270 arrow is aligned with the indexing mark 266, the J-handle 34 is in a position substantially in the same plane as the drive shaft housing 12, making the lawn care apparatus 10 a little flatter and therefore easier to store.

Referring to FIG. 11, when the trimming index mark and arrow 272 are aligned with the indexing mark 266, the J-handle 34 is in the most advantageous position for trimming, i.e., in keeping the trimmer strings 48, 188 horizontal as shown in FIGS. 1, 2. In this position, the J-handle is rotated away from the storage position shown in FIG. 10 by an angle lying in a range of about 25°-65° counterclockwise when viewed from a position in which the curved portion of the J-handle 34 is closest to the viewer, as indicated by the double-headed arc arrow 274, with the preferred angle being 45°.

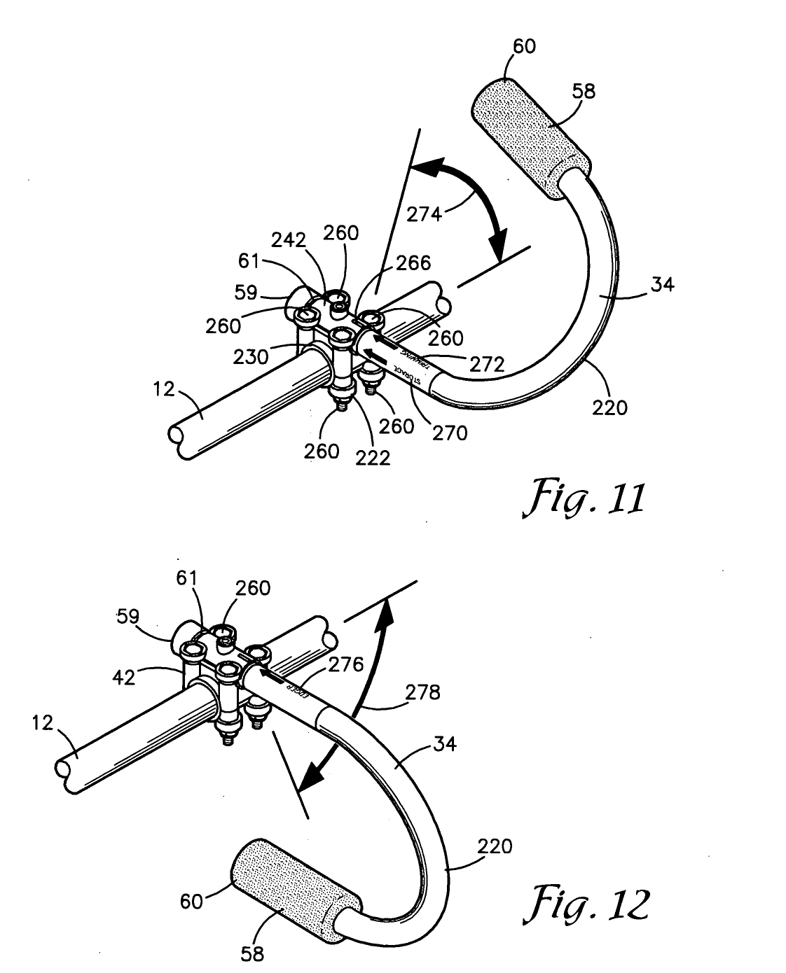

Referring to FIG. 12, when the edger trimming index mark and arrow 276 are aligned with the indexing mark 266, the J-handle 34 is in the most advantageous position for edging, i.e., in keeping the trimmer strings 48, 188 vertical as shown in FIG. 3, while keeping the posture of the operator 28 basically the same as during the trimming operation. In this position, the J-handle is rotated downwardly away from the storage position shown in FIG. 10, i.e., clockwise as defined above, at an angle lying in the range of 45°-75°, with the preferred angle being 65°, as indicated by the double-headed arc arrow 278.

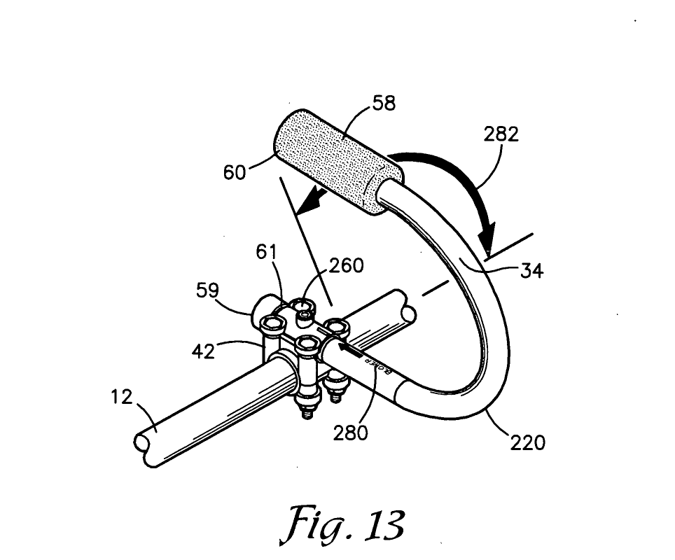

Referring to FIG. 13, the J-handle 34 is rotated upwardly, i.e., counterclockwise, away from the storage position shown in FIG. 10 in a range of about 90°-135° as indicated by the double-headed arrow 282, to move the J-handle into a convenient position for edging, so that the “blower” index mark 280 is aligned with the indexing mark 266, with the preferred angle being about 120°. In all of the positions described above except the storage position, the operator 28 is able to maintain essentially the same posture as shown in FIG. 1 whether the operator is using the law care apparatus 10 for the separate principal functions of blowing, edging, and trimming.

While the present invention has been described in accordance with the preferred embodiments thereof, the description is for illustration only and should not be construed as limiting the scope of the invention. Various changes and modifications may be made by those skilled in the art without departing from the spirit and scope of the invention as defined by the following claims. For example, if desired, the string trimmer head is easily removed and replaced with another string trimmer head, or can be left off to use the lawn care apparatus as a conventional blower.

I claim:

1. An apparatus comprising:
a. an impeller connected to a drive shaft, said impeller being seated in a plenum connected to a drive shaft housing;
b. a string trimmer head disposed below said plenum, with said string trimmer head connected to said drive shaft;
c. means for simultaneously rotating said impeller and said string trimmer head by rotating said drive shaft.

2. An apparatus in accordance with claim 1 wherein said plenum further comprises an upper section and a lower section and means for holding said upper and lower sections together.

3. An apparatus in accordance with claim 2 wherein said plenum further comprises a scroll blower duct section.

4. An apparatus in accordance with claim 2 wherein said scroll blower duct section further comprises an oval outlet blower nozzle.

5. An apparatus in accordance with claim 3 further comprising a central aperture in said lower section for allowing said drive shaft to pass through to said string trimmer head.

6. An apparatus in accordance with claim 3 wherein said upper section of said plenum further comprises a plurality of spaced upstanding vanes arrayed in a circular pattern, each said vane having an upper end connected to a flat circular top.

7. An apparatus in accordance with claim 1 further comprising a guard shroud formed on an outer surface of said plenum

8. An apparatus in accordance with claim 1 further comprising a threaded lower end of said drive shaft that is threaded onto a corresponding central aperture in said string trimmer head.

9. An apparatus in accordance with claim 1 further comprises adjustable handle means for adjusting the position of the apparatus relative to said adjustable handle.

10. An apparatus in accordance with claim 9 wherein said adjustable handle means further comprises a J-handle connected to a drive shaft housing along a point between said impeller and an upper end of said drive shaft housing by an adjustable coupling block.

11. An apparatus in accordance with claim 10 wherein said adjustable coupling block further comprises a bottom clamping body disposed on a lower side of said drive shaft and an upper clamping body disposed on an upper side of said drive shaft housing and means for holding said bottom clamping body and said upper clamping body together against said drive shaft housing.

12. An apparatus in accordance with claim 11 wherein said adjustable coupling block further comprises a J-handle cover plate having a handle receiving channel, for receiving and retaining a proximal end of said J-handle, said J-handle cover plate connected to a bottom handle receiving channel in an surface of said upper clamping body.

13. An apparatus in accordance with claim 12 further comprising guide means for limiting axial rotation of said J-handle.

14. An apparatus comprising:
a. an impeller connected to a drive shaft, said impeller being seated in a plenum connected to a drive shaft housing in which said drive shaft is located;
b. a string trimmer head disposed below said plenum, with said string trimmer head connected to said drive shaft;
c. means for simultaneously rotating said impeller and said string trimmer head by rotating said drive shaft.

15. An apparatus in accordance with claim 14 further comprising a threaded end on a lower end of said drive shaft for connecting to a corresponding threaded bore in said string trimmer head.

16. An apparatus in accordance with claim 14 further comprising a hexagonal portion of said drive shaft above and adjacent to said threaded lower end of said drive shaft and a corresponding central hexagonal bore in said impeller for receiving said hexagonal portion of said drive shaft.

17. An apparatus comprising:
a. an impeller connected to a drive shaft, said impeller being seated in a plenum connected to a drive shaft housing in which said drive shaft is located;
b. a string trimmer head disposed below said plenum, with said string trimmer head connected to said drive shaft;
c. means for simultaneously rotating said impeller and said string trimmer head by rotating said drive shaft; and
d. a J-handle attached to said drive shaft housing and means for permitting axial rotational adjustment of the position of said J-handle.

18. An apparatus in accordance with claim 17 wherein an upper section of said plenum further comprises a plurality of spaced upstanding vanes arrayed in a circular pattern, each said vane having an upper end connected to a flat circular top that is connected to a flange plate.

19. An apparatus in accordance with claim 18 wherein said plenum further comprises a scroll duct section terminating in an oval outlet nozzle.

20. An apparatus in accordance with claim 17 further comprising an aperture in a lower section of said plenum for allowing said drive shaft to penetrate said lower section of said plenum for being threaded into said string trimmer head.
